(19) United States
(12) Patent Application Publication
(10) Pub. No.: US 2007/0250884 A1
(43) Pub. Date: Oct. 25, 2007

(54) System and method of providing call source information

(75) Inventors: Chaoxin Qiu, Austin, TX (US); Michael W. Boeckman, Cedar Park, TX (US); John R. Erickson, Austin, TX (US); Jeffrey Lee Scruggs, Round Rock, TX (US); Stephen Mark Mueller, Austin, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/400,906

(22) Filed: Apr. 10, 2006

(51) Int. Cl. H04N 7/173; H04N 7/16

(52) U.S. Cl. 725/106; 725/117; 725/147

(57) ABSTRACT

The present disclosure is directed to a system and method of providing call source information. In a particular embodiment, the method includes receiving call source information and call destination information at a mediation messaging server of an Internet Protocol Television (IPTV) system, where the call source information and the call destination information are related to a call received via at least one of a switch of a Public Switched Telephone Network (PSTN) and a wireless telephone network. The method also includes determining account information based on the call destination information and sending the account information and the call source information to a notification server of the IPTV system, where the notification server sends the call source information to a set-top box device of an IPTV user via an access network of the IPTV system.

### FIELD OF THE DISCLOSURE

The present disclosure relates generally to providing call source information.

### BACKGROUND

Television viewing is part of daily life for many people. Individuals often prefer not to be interrupted while watching television, but they may desire to monitor telephone calls, for example, in case of an emergency or to avoid reviewing a large number of new messages at a future time. Technical compatibilities pose challenges when integrating conventional and wireless telephone networks, such as Public Switched Telephone Networks (PSTN) or cellular telephone networks, with television networks.

### BRIEF DESCRIPTION OF THE DRAWINGS

FIG. 1 is a block diagram illustrating a particular embodiment of a system to provide call source information;

FIG. 2 is a block diagram illustrating a second particular embodiment of a system to provide call source information;

FIG. 3 is a block diagram illustrating a third particular embodiment of a system to provide call source information;

FIG. 4 is a block diagram illustrating a fourth particular embodiment of a system to provide call source information;

FIG. 5 is block diagram illustrating a fifth particular embodiment of a system to provide call source information;

FIG. 6 is a block diagram of a sixth embodiment of a system to provide call source information;

FIG. 7 is a block diagram of an illustrative embodiment of a system to receive call source information;

FIG. 8 is a flow diagram of a particular embodiment of a method to provide call source information;

FIG. 9 is a flow diagram of a second particular embodiment of a method to provide call source information

FIG. 10 is a flow diagram of a third particular embodiment of a method to provide call source information;

FIG. 11 is a flow diagram of a fourth particular embodiment of a method to provide call source information;

FIG. 12 is a flow diagram of a fifth particular embodiment of a method to provide call source information;

FIG. 13 is a flow diagram of a sixth particular embodiment of a method to provide call source information;

FIG. 14 is a diagram of a graphical user interface to provide call source information; and

FIG. 15 is a diagram of an embodiment of a general computer system.

### DETAILED DESCRIPTION OF THE DRAWINGS

The present disclosure is directed to a system to provide call source information. The system includes a mediation messaging server of an Internet Protocol Television (IPTV) system, where the mediation messaging server including a processor and a memory device accessible to the processor. The memory device includes an Application Programming Interface (API) module executable by the processor to receive call source information and call destination information related to a call received at a switch of a communications network. Further, the memory device includes a Lightweight Directory Access Protocol (LDAP) module executable by the processor to query a LDAP database of the IPTV system to determine account information of an IPTV user based on the call destination information. In addition, the API module is executable by the processor to send the account information and the call source information to a notification server of the IPTV system and the notification server sends the call source information to a set-top box device of the IPTV user via an access network of the IPTV system.

In another embodiment, the disclosure is directed to a set-top box device that includes a processor and a memory device accessible to the processor. The memory device includes an Application Programming Interface (API) module executable by the processor to receive call source information from a notification server via an access network of an Internet Protocol Television (IPTV) system, where the call source information is related to a call received at a switch of a communications network. Further, the memory device includes a graphical user interface (GUI) module executable by the processor to send a graphical user interface (GUI) containing the call source information to a display device coupled to the set-top box device.

In another embodiment, the disclosure is directed to a method of providing call source information that includes receiving call source information and call destination information at a mediation messaging server of an Internet Protocol Television (IPTV) system, where the call source information and the call destination information are related to a call received via at least one of a switch of a Public Switched Telephone Network (PSTN) and a wireless telephone network. The method also includes determining account information based on the call destination information and sending the account information and the call source information to a notification server of the IPTV system, where the notification server sends the call source information to a set-top box device of an IPTV user via an access network of the IPTV system.

In another embodiment, the disclosure is directed to a method of providing call source information that includes receiving call source information and account information at a notification server of an Internet Protocol Television (IPTV) system, where the call source information is related to a call received via at least one of a Public Switched Telephone Network (PSTN) or a wireless telephone network. The method also includes determining a set-top box device associated with the account information and sending the call source information to the set-top box device via an access network of the IPTV system.

In another embodiment, the disclosure is directed to a method of receiving call source information that includes receiving call source information at a set-top box device from a notification server via an access network of an Internet Protocol Television (IPTV) system, where the call source information is related to a call routed via at least one of a Public Switched Telephone Network (PSTN) and a wireless telephone network. The method also includes sending a graphical user interface (GUI) containing the call source information to a display device coupled to the set-top box device.

In another embodiment, the disclosure is directed to a computer program embedded in a computer-readable medium. The computer program includes instructions to receive call source information and call destination information related to a call received at a telephony switch. The computer program also includes instructions to query a LDAP database of an Internet Protocol Television (IPTV) system to determine account information of an IPTV user based on the call destination information. The computer program also includes instructions to send the account information and the call source information to a notification server of the IPTV system, where the notification server sends the call source information to a set-top box device of the IPTV user via an access network of the IPTV system.

In another embodiment, the disclosure is directed to a computer program embedded in a computer-readable medium. The computer program includes instructions to receive call source information from a notification server via an access network of an Internet Protocol Television (IPTV) system, where the call source information is related to a call received at a switch of a public telephone network. The method also includes instructions to send a graphical user interface (GUI) containing the call source information to a display device coupled to the set-top box device.

Referring to FIG. I, a particular embodiment of a system to provide call source information is illustrated. The system 100 includes a gateway server 101 of an Internet Protocol Television (IPTV) system. In an illustrative embodiment, the gateway server 101 can be configured to be compliant with Open Service Access (OSA)/Parlay standards. The gateway server 101 communicates with a switch of a Public Switched Telephone Network (PSTN), such as a class 5 switch 102, which can receive PSTN calls 104 and route them to destination devices, such as a time-division multiplexing (TDM) phone 120. Further, the gateway server 101 communicates with a database, such as a line information database (LIDB) 106 that stores information associated with Plain Old Telephone Service (POTS) telephone numbers, wireless telephone numbers, Voice-over Internet Protocol (VOIP) telephone numbers, or any combination thereof.

Additionally, the gateway server 101 can communicate with one or more call notification servers 108 of the IPTV system. In a particular embodiment, the gateway server 101 can communicate with an IPTV mediation messaging server 110 that communicates with a cluster of call notification servers 108. The IPTV mediation messaging server 110 can communicate with a mediation database 112 that stores IPTV user account information associated with telephone numbers. In an illustrative embodiment, the IPTV mediation messaging server 110 can be an IPTV caller ID application server and the mediation database 112 can be a Lightweight Directory Access Protocol (LDAP) of the IPTV system.

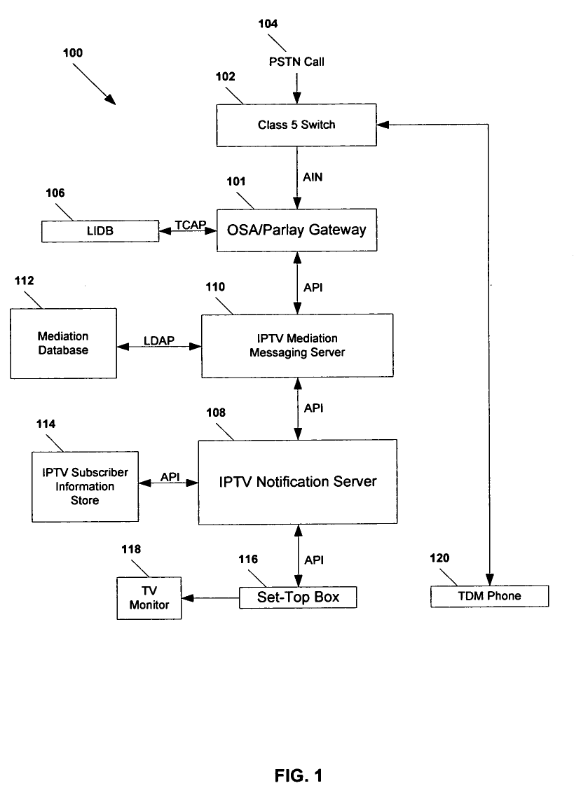

As illustrated in FIG. 1, the call notification server(s) 108 communicate with a subscriber/system store server 114 of the IPTV system, which stores identifications of set-top boxes associated with IPTV user accounts. Further, the call notification server(s) 108 communicate with one or more set-top boxes, such as the set-top box 116. In an illustrative embodiment, the call notification server(s) 108 communicate with the set-top box 116 via a private access network of the IPTV system. The set-top box 116 can be coupled to a television monitor 118.

In a particular embodiment, a PSTN call 104 from a source device, such as a caller POTS phone, can be received at the class 5 switch 102. The gateway server 101 can detect that a connection is to be made between the source device and the TDM phone 120, for example, by detecting a termination attempt trigger (TAT) via an Advanced Intelligence Network (AIN) architecture. In an illustrative embodiment, the gateway server 101 issues a query, such as a transaction capabilities application part (TCAP) query, to the LIDB 106 requesting caller ID information or other call source information related to the source device. The gateway server 101 receives the call source information and sends the call source information and call destination information related to the TDM phone 120 to the IPTV mediation messaging server 110. In one embodiment, the gateway server can send the call source and call destination information to the IPTV mediation messaging server 110 via an application programming interface (API), such as a Parlay API.

Upon receiving call source and destination information from the gateway server 101, the IPTV mediation messaging server 110 can query the mediation database 112 to obtain IPTV user account information related to a destination telephone number of the call, such as a telephone number of the TDM phone 120. The IPTV mediation messaging server 110 sends the call source information and IPTV user account information to the IPTV notification server 108, for example, via an API.

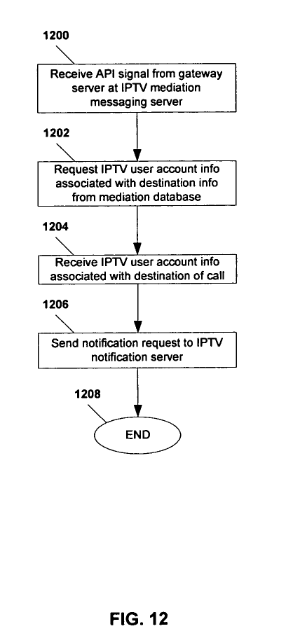

In a particular embodiment, the IPTV notification server 108 can obtain identifications of the set-top box 116 associated with the IPTV user account, such as alphanumeric identifiers, IP addresses, identifications of twisted pairs coupled to the set-top box, or any combination thereof. The IPTV notification server 108 transmits the call source information to the identified set-top box device 116, and the set-top box 116 transmits the call source information to the television monitor 118. In an illustrative embodiment, the IPTV notification server 108 can transmit data related to a graphical user interface (GUI) to the set-top box device 116 via an API, and the set-top box device 116 can draw or display the GUI at the television monitor 118. In another embodiment, the set-top box device 116 can generate the GUI from data related to the call source information. An example of a GUI to display call source information is illustrated in FIG. 12.

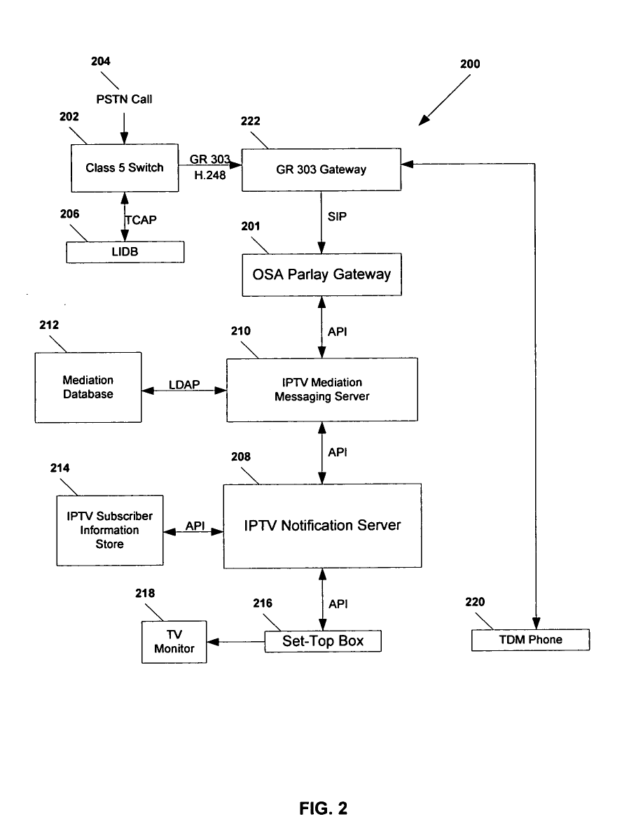

Referring to FIG. 2, a second particular embodiment of a system to provide call source information is illustrated. The system 200 includes a gateway server 201 of an Internet Protocol Television (IPTV) system. The gateway server 201 communicates with a switch of a Public Switched Telephone Network (PSTN), such as a class 5 switch 202, which can receive PSTN calls 204 and route them to destination devices, such as a time-division multiplexing (TDM) phone 220. In an illustrative embodiment, the class 5 switch 202 and the gateway server 201 can be coupled with a GR-303 based gateway 222. Further, the class 5 switch 202 can communicate with a database, such as a line information database (LIDB) 206 that stores information associated with Plain Old Telephone Service (POTS) telephone numbers, wireless telephone numbers, Voice-over Internet Protocol (VoIP) telephone numbers, or any combination thereof.

Additionally, the gateway server 201 can communicate with one or more call notification servers 208 of the IPTV system. In a particular embodiment, the gateway server 201 can communicate with a caller identification (caller ID) application server 210 that communicates with a cluster of call notification servers 208. The IPTV mediation messaging server 210 can communicate with a mediation database 212 that stores IPTV user account information associated with telephone numbers. In an illustrative embodiment, the IPTV mediation messaging server 210 can be an IPTV caller ID application server and the mediation database 212 can be a Lightweight Directory Access Protocol (LDAP) database of the IPTV system.

As illustrated in FIG. 2, the call notification server(s) 208 communicate with a subscriber/system store server 214 of the IPTV system, which stores identifications of set-top boxes associated with IPTV user accounts. Further, the call notification server(s) 208 communicate with one or more set-top boxes, such as the set-top box 216. In an illustrative embodiment, the call notification server(s) 208 communicate with the set-top box 216 via a private access network of the IPTV system. The set-top box 216 can be coupled to a television monitor 218.

In a particular embodiment, a PSTN call 204 from a source device, such as a caller POTS phone, can be received at the class 5 switch 202. In an illustrative embodiment, the class 5 switch 202 issues a query, such as a transaction capabilities application part (TCAP) query, to the LIDB 206 requesting caller ID information or other call source information related to the source device. The class 5 switch 202 transmits the call and call source information to the GR 303-based gateway 222 via a media gateway control protocol (MGCP/H.248) signal. The GR 303-based gateway 222 can convert the call to an IP-based message that is transmitted via a fiber loop to the TDM phone 220. In an illustrative, non-limiting embodiment, an orthomode transducer (OMT) at the premises of the TDM phone 220 can convert the IP-based message to a TDM signal.

Further, the GR303-based gateway 222 transmits a session initiation protocol (SIP) signal that includes the call source information and call destination information related to the TDM phone 220 to the gateway server 201. The gateway server 201 sends the call source and destination information to the IPTV mediation messaging server 210, for example, via an application programming interface (API). Upon receiving call source and destination information from the gateway server 201, the IPTV mediation messaging server 210 can query the mediation database 212 to obtain IPTV user account information related to a destination telephone number of the call, such as a telephone number of the TDM phone 220. The IPTV mediation messaging server 210 sends the call source information and IPTV user account information to the IPTV notification server 208, for example, via an API.

In a particular embodiment, the IPTV notification server 208 can obtain identifications of the set-top box 216 associated with the IPTV user account, such as alphanumeric identifiers, IP addresses, identifications of twisted pairs coupled to the set-top box, or any combination thereof. The IPTV notification server 208 transmits the call source information to the identified set-top box device 216, and the set-top box 216 transmits the call source information to the television monitor 218. In an illustrative embodiment, the IPTV notification server 208 can transmit data related to a graphical user interface (GUI) to the set-top box device 216 via an API, and the set-top box device 216 can draw or display the GUI at the television monitor 218. In another embodiment, the set-top box device 216 can generate the GUI from data related to the call source information.

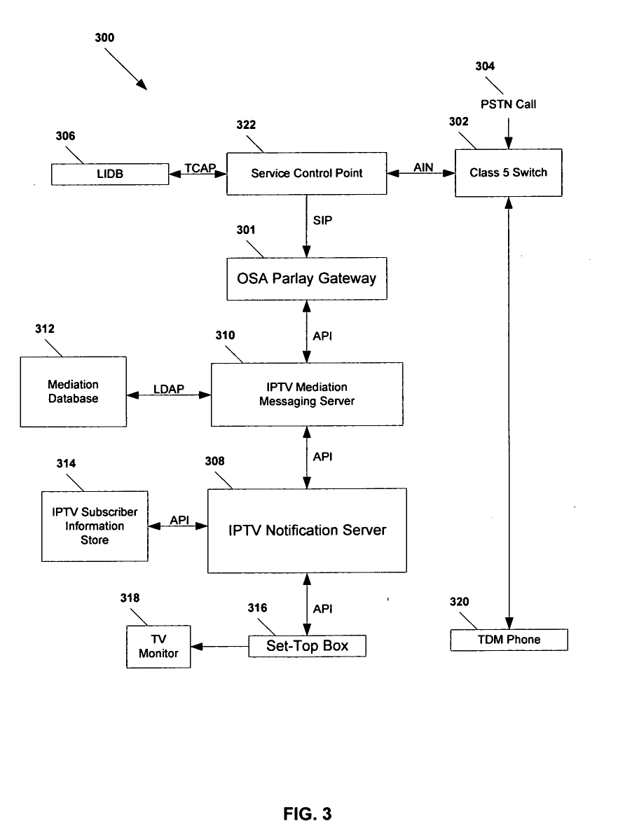

Referring to FIG. 3, a third particular embodiment of a system to provide call source information is illustrated. The system 300 includes a gateway server 301 of an Internet Protocol Television (IPTV) system. The gateway server 301 communicates with a switch of a Public Switched Telephone Network (PSTN), such as a class 5 switch 302, which can receive PSTN calls 304 and route them to destination devices, such as a time-division multiplexing (TDM) phone 320. In an illustrative embodiment, the class 5 switch 302 and the gateway server 301 can be coupled with a service control point 322 of a signaling system 7 (SS7) network. Further, the service control point 322 can communicate with a database, such as a line information database (LIDB) 306 that stores information associated with Plain Old Telephone Service (POTS) telephone numbers, wireless telephone numbers, Voice-over Internet Protocol (VOIP) telephone numbers, or any combination thereof.

Additionally, the gateway server 301 can communicate with one or more call notification servers 308 of the IPTV system. In a particular embodiment, the gateway server 301 can communicate with a caller identification (caller ID) application server 310 that communicates with a cluster of call notification servers 308. The IPTV mediation messaging server 310 can communicate with a mediation database 312 that stores IPTV user account information associated with telephone numbers. In an illustrative embodiment, the IPTV mediation messaging server 310 can be an IPTV caller ID application server and the mediation database 312 can be a Lightweight Directory Access Protocol (LDAP) database of the IPTV system.

As illustrated in FIG. 3, the call notification server(s) 308 communicate with a subscriber/system store server 314 of the IPTV system, which stores identifications of set-top boxes associated with IPTV user accounts. Further, the call notification server(s) 308 communicate with one or more set-top boxes, such as the set-top box 316. In an illustrative embodiment, the call notification server(s) 308 communicate with the set-top box 316 via a private access network of the IPTV system. The set-top box 316 can be coupled to a television monitor 318.

In a particular embodiment, a PSTN call 304 from a source device, such as a caller POTS phone, can be received at the class 5 switch 302. The service control point 322 can detect that a connection is to be made between the source device and the TDM phone 320, for example, by detecting a termination attempt trigger (TAT) via an Advanced Intelligence Network (AIN) architecture. In an illustrative embodiment, the service control point 322 issues a query, such as a transaction capabilities application part (TCAP) query, to the LIDB 306 requesting caller ID information or other call source information related to the source device.

The service control point 322 transmits a session initiation protocol (SIP) signal that includes the call source information and call destination information related to the TDM phone 320 to the gateway server 301. The gateway server 301 sends the call source and destination information to the IPTV mediation messaging server 310, for example, via an application programming interface (API). Upon receiving call source and destination information from the gateway server 301, the IPTV mediation messaging server 310 can query the mediation database 312 to obtain IPTV user account information related to a destination telephone number of the call, such as a telephone number of the TDM phone 320. The IPTV mediation messaging server 310 sends the call source information and IPTV user account information to the IPTV notification server 308, for example, via an API.

In a particular embodiment, the IPTV notification server 308 can obtain identifications of the set-top box 316 associated with the IPTV user account, such as alphanumeric identifiers, IP addresses, identifications of twisted pairs coupled to the set-top box, or any combination thereof. The IPTV notification server 308 transmits the call source information to the identified set-top box device 316, and the set-top box 316 transmits the call source information to the television monitor 318. In an illustrative embodiment, the IPTV notification server 308 can transmit data related to a graphical user interface (GUI) to the set-top box device 316 via an API, and the set-top box device 316 can draw or display the GUI at the television monitor 318. In another embodiment, the set-top box device 316 can generate the GUI from data related to the call source information.

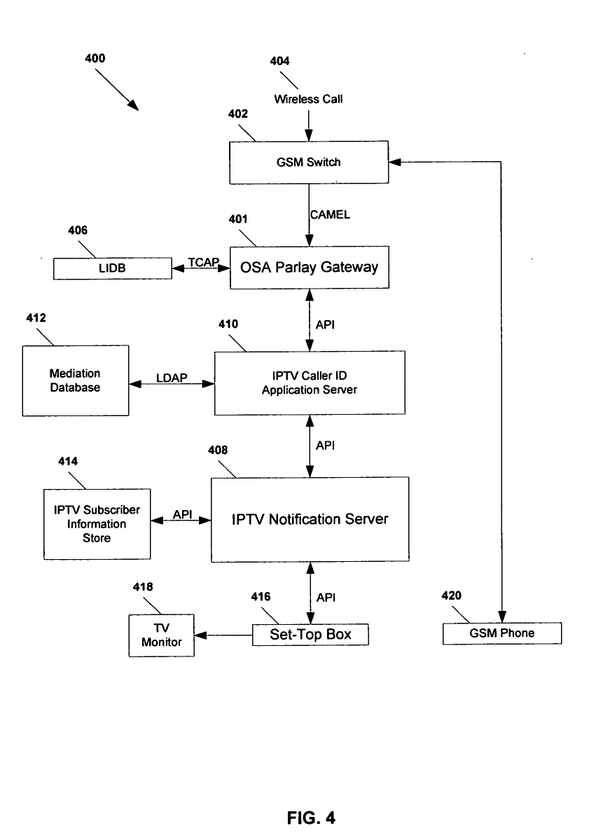

Referring to FIG. 4, a fourth particular embodiment of a system to provide call source information is illustrated. The system 400 includes a gateway server 401 of an Internet Protocol Television (IPTV) system. In an illustrative embodiment, the gateway server 401 can be configured to be compliant with Open Service Access (OSA)/Parlay standards. The gateway server 401 communicates with a switch of a wireless telephone network, such as a global system for mobile communication (GSM) switch 402, which can receive wireless calls 404 and route them to destination devices, such as a GSM phone 420. Further, the gateway server 401 communicates with a database, such as a line information database (LIDB) 406 that stores information associated with Plain Old Telephone Service (POTS) telephone numbers, wireless telephone numbers, Voice-over Internet Protocol (VOIP) telephone numbers, or any combination thereof.

Additionally, the gateway server 401 can communicate with one or more call notification servers 408 of the IPTV system. In a particular embodiment, the gateway server 401 can communicate with a caller identification (caller ID) application server 410 that communicates with a cluster of call notification servers 408. The caller ID application server 410 can communicate with a mediation database 412 database that stores IPTV user account information associated with telephone numbers. In an illustrative embodiment, the mediation database 412 can be a Lightweight Directory Access Protocol (LDAP) database of the IPTV system.

As illustrated in FIG. 4, the call notification server(s) 408 communicate with a subscriber/system store server 414 of the IPTV system, which stores identifications of set-top boxes associated with IPTV user accounts. Further, the call notification server(s) 408 communicate with one or more set-top boxes, such as the set-top box 416. In an illustrative embodiment, the call notification server(s) 408 communicate with the set-top box 416 via a private access network of the IPTV system. The set-top box 416 can be coupled to a television monitor 418.

In a particular embodiment, a wireless call 404 from a source device, such as a caller cellular phone, can be received at the GSM switch 402. The gateway server 401 can detect that a connection is to be made between the source device and the GSM phone 420, for example, by detecting a customized applications for mobile enhanced logic (CAMEL) trigger via a CAMEL network architecture. In an illustrative embodiment, the gateway server 401 issues a query, such as a transaction capabilities application part (TCAP) query, to the LIDB 406 requesting caller ID information or other call source information related to the source device. The gateway server 401 receives the call source information and sends the call source information and call destination information related to the GSM phone 420 to the caller ID application server 410. In one embodiment, the gateway server can send the call source and destination information to the caller ID application server 410 via an application programming interface (API), such as a Parlay API.

Upon receiving call source and destination information from the gateway server 401, the caller ID application server 410 can query the LDAP database 412 to obtain IPTV user account information related to a destination telephone number of the call, such as a telephone number of the GSM phone 420. The caller ID application server 410 sends the call source information and IPTV user account information to the IPTV notification server 408, for example, via an API. In a particular embodiment, the IPTV notification server 408 can obtain identifications of the set-top box 416 associated with the IPTV user account, such as alphanumeric identifiers, IP addresses, identifications of twisted pairs coupled to the set-top box, or any combination thereof. The IPTV notification server 408 transmits the call source information to the identified set-top box device 416, and the set-top box 416 transmits the call source information to the television monitor 418. In an illustrative embodiment, the IPTV notification server 408 can transmit data related to a graphical user interface (GUI) to the set-top box device 416 via an API, and the set-top box device 416 can draw or display the GUI at the television monitor 418. In another embodiment, the set-top box device 416 can generate the GUI from data related to the call source information.

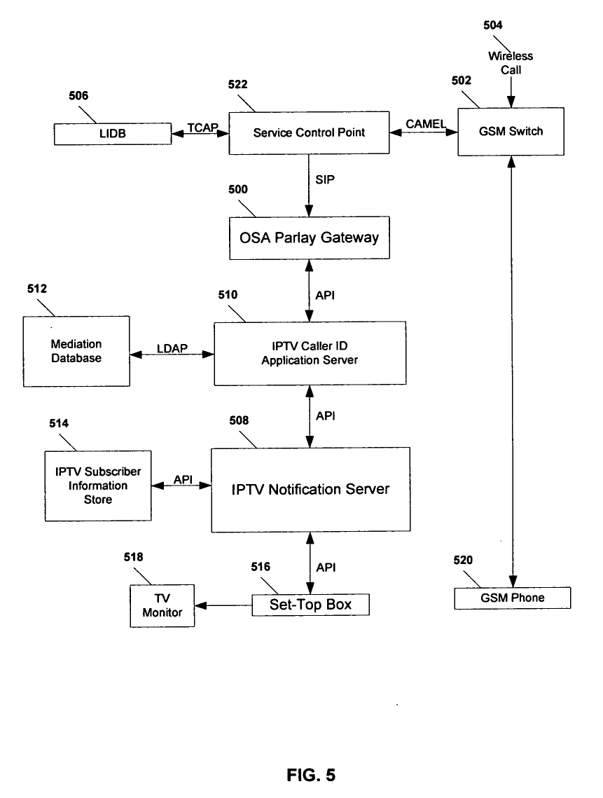

Referring to FIG. 5, a fifth particular embodiment of a system to provide call source information is illustrated. The system 500 includes a gateway server 501 of an Internet Protocol Television (IPTV) system. The gateway server 501 communicates with a switch of a wireless network, such as a global system for mobile communication (GSM) switch 502, which can receive wireless calls 504 and route them to destination devices, such as a GSM phone 520. In an illustrative embodiment, the GSM switch 502 and the gateway server 501 can be coupled with a service control point 522 of a signaling system 7 (SS7) network. Further, the service control point 522 can communicate with a database, such as a line information database (LIDB) 506 that stores information associated with Plain Old Telephone Service (POTS) telephone numbers, wireless telephone numbers, Voice-over Internet Protocol (VOIP) telephone numbers, or any combination thereof.

Additionally, the gateway server 501 can communicate with one or more call notification servers 508 of the IPTV system. In a particular embodiment, the gateway server 501 can communicate with a caller identification (caller ID) application server 510 that communicates with a cluster of call notification servers 508. The caller ID application server 510 can communicate with a directory, database, or any combination thereof, that stores IPTV user account information associated with telephone numbers. In an illustrative embodiment, the caller ID application server 510 can communicate with a mediation database 512, such as a Lightweight Directory Access Protocol (LDAP) database of the IPTV system.

As illustrated in FIG. 5, the call notification server(s) 508 communicate with a subscriber/system store server 514 of the IPTV system, which stores identifications of set-top boxes associated with IPTV user accounts. Further, the call notification server(s) 508 communicate with one or more set-top boxes, such as the set-top box 516. In an illustrative embodiment, the call notification server(s) 508 communicate with the set-top box 516 via a private access network of the IPTV system. The set-top box 516 can be coupled to a television monitor 518.

In a particular embodiment, a wireless call 504 from a source device, such as a caller cellular phone, can be received at the GSM switch 502. The service control point 522 can detect that a connection is to be made between the source device and the GSM phone 520, for example, by detecting a customized applications for mobile enhanced logic (CAMEL) trigger via a CAMEL network architecture. In an illustrative embodiment, the service control point 522 issues a query, such as a transaction capabilities application part (TCAP) query, to the LIDB 506 requesting caller ID information or other call source information related to the source device.

The service control point 522 transmits a session initiation protocol (SIP) signal that includes the call source information and call destination information related to the GSM phone 520 to the gateway server 501. The gateway server 501 sends the call source and destination information to the caller ID application server 510, for example, via an application programming interface (API). Upon receiving call source and destination information from the gateway server 501, the caller ID application server 510 can query the mediation database 512 to obtain IPTV user account information related to a destination telephone number of the call, such as a telephone number of the GSM phone 520. The caller ID application server 510 sends the call source information and IPTV user account information to the IPTV notification server 508, for example, via an API.

In a particular embodiment, the IPTV notification server 508 can obtain identifications of the set-top box 516 associated with the IPTV user account, such as alphanumeric identifiers, IP addresses, identifications of twisted pairs coupled to the set-top box, or any combination thereof. The IPTV notification server 508 transmits the call source information to the identified set-top box device 516, and the set-top box 516 transmits the call source information to the television monitor 518. In an illustrative embodiment, the IPTV notification server 508 can transmit data related to a graphical user interface (GUI) to the set-top box device 516 via an API, and the set-top box device 516 can draw or display the GUI at the television monitor 518. In another embodiment, the set-top box device 516 can generate the GUI from data related to the call source information.

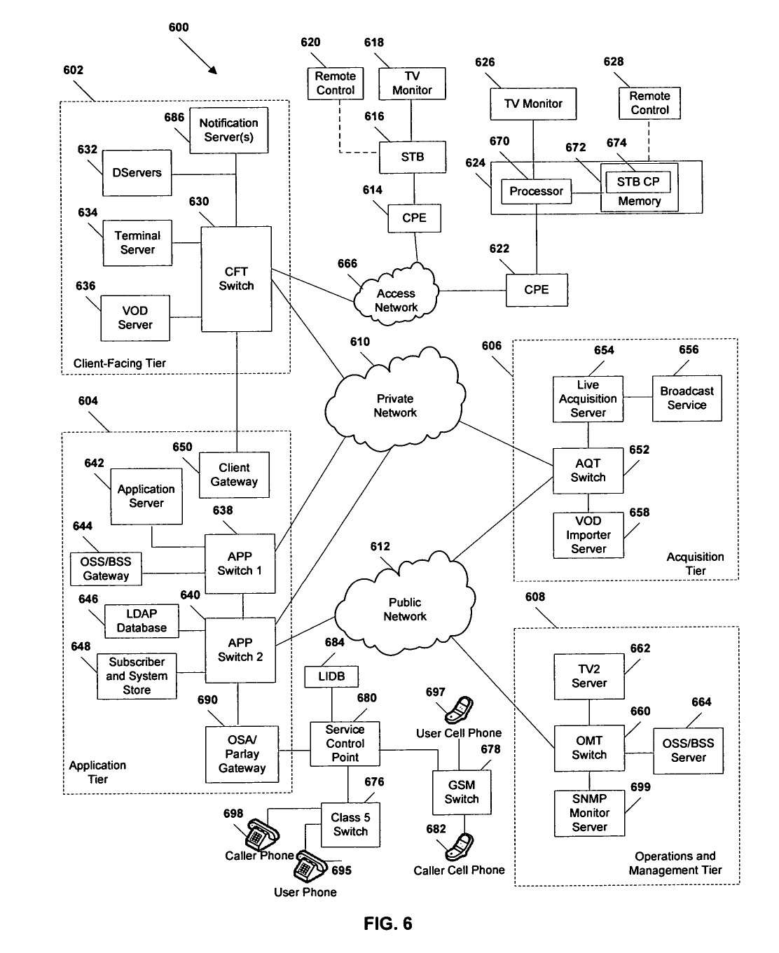

Referring to FIG. 6, an illustrative embodiment of an Internet Protocol Television (IPTV) system that may be used to provide call source information is illustrated and is generally designated 600. As shown, the system 600 can include a client facing tier 602, an application tier 604, an acquisition tier 606, and an operations and management tier 608. Each tier 602, 604, 606, 608 is coupled to a private network 610; to a public network 612, such as the Internet; or to both the private network 610 and the public network 612. For example, the client-facing tier 602 can be coupled to the private network 610. Further, the application tier 604 can be coupled to the private network 610 and to the public network 612. The acquisition tier 606 can also be coupled to the private network 610 and to the public network 612. Additionally, the operations and management tier 608 can be coupled to the public network 612.

As illustrated in FIG. 6, the various tiers 602, 604, 606, 608 communicate with each other via the private network 610 and the public network 612. For instance, the client-facing tier 602 can communicate with the application tier 604 and the acquisition tier 606 via the private network 610. The application tier 604 can also communicate with the acquisition tier 606 via the private network 610. Further, the application tier 604 can communicate with the acquisition tier 606 and the operations and management tier 608 via the public network 612. Moreover, the acquisition tier 606 can communicate with the operations and management tier 608 via the public network 612. In a particular embodiment, elements of the application tier 604, including, but not limited to, a client gateway 650, can communicate directly with the client-facing tier 602.

The client-facing tier 602 can communicate with user equipment via an access network 666, such as an Internet Protocol Television (IPTV) access network. In an illustrative embodiment, customer premises equipment (CPE) 614, 622 can be coupled to the access network 666. The client-facing tier 602 can communicate with a first representative set-top box device 616 at a first customer premise via the first CPE 614 and with a second representative set-top box device 624 at a second customer premise via the second CPE 622. The CPE 614, 622 can include routers, local area network devices, modems, such as digital subscriber line (DSL) modems, any other suitable devices for facilitating communication between a set-top box device and the access network 666, or any combination thereof. The client-facing tier 602 can communicate with a large number of set-top boxes, such as the representative set-top boxes 616, 624, over a wide geographic area, such as a regional area, a metropolitan area, a viewing area, a designated market area or any other suitable geographic area, market area, or subscriber or customer group that can be supported by networking the client-facing tier 602 to numerous set-top box devices. In an illustrative embodiment, the client-facing tier 602, or any portion thereof, can be included at a video head-end office.

In a particular embodiment, the client-facing tier 602 can be coupled to the CPE 614, 622 via fiber optic cables. Alternatively, the CPE 614, 622 can be digital subscriber line (DSL) modems that are coupled to one or more network nodes via twisted pairs, and the client-facing tier 602 can be coupled to the network nodes via fiber-optic cables. Each set-top box device 616, 624 can process data received via the access network 666, via an IPTV software platform, such as Microsoft® TV IPTV Edition.

Additionally, the first set-top box device 616 can be coupled to a first external display device, such as a first television monitor 618, and the second set-top box device 624 can be coupled to a second external display device, such as a second television monitor 626. Moreover, the first set-top box device 616 can communicate with a first remote control 620, and the second set-top box device 624 can communicate with a second remote control 628. The set-top box devices 616, 624 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 616, 624 can receive data or video from the client-facing tier 602 via the private access network 666 and render or display the data or video at the display device 618, 626 to which it is coupled. In an illustrative embodiment, the set-top box devices 616, 624 can include tuners that receive and decode television programming information for transmission to the display devices 618, 626. Further, the set-top box devices 616, 624 can include a STB processor 670 and a STB memory device 672 that is accessible to the STB processor 670. In one embodiment, a computer program, such as the STB computer program 674, can be embedded within the STB memory device 672.

In an illustrative embodiment, the client-facing tier 602 can include a client-facing tier (CFT) switch 630 that manages communication between the client-facing tier 602 and the access network 666 and between the client-facing tier 602 and the private network 610. As illustrated, the CFT switch 630 is coupled to one or more data servers, such as D-servers 632, that store, format, encode, replicate, or otherwise manipulate or prepare video content for communication from the IPTV system 600 to the set-top box devices 616, 624. The CFT switch 630 can also be coupled to a terminal server 634 that provides terminal devices with a connection point to the private network 610. In a particular embodiment, the CFT switch 630 can also be coupled to a video-on-demand (VOD) server 636 that stores or provides VOD content imported by the IPTV system 600. Further, the CFT switch 630 is coupled to one or more notification servers 686, such as a cluster of notification servers.

As illustrated in FIG. 6, the application tier 604 can communicate with both the private network 610 and the public network 612. The application tier 604 can include a first application tier (APP) switch 638 and a second APP switch 640. In a particular embodiment, the first APP switch 638 can be coupled to the second APP switch 640. The first APP switch 638 can be coupled to an application server 642 and to an OSS/BSS gateway 644. In a particular embodiment, the application server 642 can provide applications to the set-top box devices 616, 624 via the access network 666, which enable the set-top box devices 616, 624 to provide functions, such as display, messaging, processing of IPTV data and VOD material, etc. Moreover, the application server 642 can function as a caller ID application server that receives user account information related to call information and passes the user account information and call information to the notification server(s) 686. In a particular embodiment, the OSS/BSS gateway 644 includes operation systems and support (OSS) data, as well as billing systems and support (BSS) data. In one embodiment, the OSS/BSS gateway 644 can provide or restrict access to an OSS/BSS server 664 that stores operations and billing systems data.

The second APP switch 640 can be coupled to a domain controller 646 that provides Internet access, for example, to users via the public network 612. For example, the domain controller 646 can provide remote Internet access to IPTV account information, e-mail, personalized Internet services, or other online services via the public network 612. In addition, the second APP switch 640 can be coupled to a subscriber and system store 648 that includes account information, such as account information that is associated with users who access the system 600 via the private network 610 or the public network 612. Further, the second APP switch 640 can be coupled to a mediation database, such as the LDAP database 646, that contains IPTV user account information associated with telephone numbers.

In a particular embodiment, the application tier 604 can also include a client gateway 650 that communicates data directly to the client-facing tier 602. In this embodiment, the client gateway 650 can be coupled directly to the CFT switch 630. The client gateway 650 can provide user access to the private network 610 and the tiers coupled thereto. In an illustrative embodiment, the set-top box devices 616, 624 can access the IPTV system 600 via the access network 666, using information received from the client gateway 650. User devices can access the client gateway 650 via the access network 666, and the client gateway 650 can allow such devices to access the private network 610 once the devices are authenticated or verified. Similarly, the client gateway 650 can prevent unauthorized devices, such as hacker computers or stolen set-top box devices from accessing the private network 610, by denying access to these devices beyond the access network 666.

For example, when the first representative set-top box device 616 accesses the system 600 via the access network 666, the client gateway 650 can verify subscriber information by communicating with the subscriber and system store 648 via the private network 610, the first APP switch 638, and the second APP switch 640. Further, the client gateway 650 can verify billing information and status by communicating with the OSS/BSS gateway 644 via the private network 610 and the first APP switch 638. In one embodiment, the OSS/BSS gateway 644 can transmit a query via the first APP switch 638, to the second APP switch 640, and the second APP switch 640 can communicate the query via the public network 612 to the OSS/BSS server 664. After the client gateway 650 confirms subscriber and/or billing information, the client gateway 650 can allow the set-top box device 616 to access IPTV content and VOD content. If the client gateway 650 cannot verify subscriber information for the set-top box device 616, e.g., because it is connected to an unauthorized twisted pair, the client gateway 650 can block transmissions to and from the set-top box device 616 beyond the access network 666.

In a particular embodiment, the second APP switch 640 can be coupled to an Open Service Access (OSA)/Parlay gateway 690 that receives call source information related to calls from caller phones, such as caller POTS phones 698 and caller cell phones 682 to IPTV user phones. In an illustrative embodiment, the OSA/Parlay gateway 690 can receive the call source information from a service control point (SCP) 680 of a signaling system 7 (SS7) network that communicates with switches of one or more telephone networks, such as a class 5 Public Switched Telephone Network (PSTN) switch 676, a global system for mobile communication switch 678 or other wireless network switch, or any combination thereof. The SCP 680 can retrieve call source information, such as caller ID information, from a line information database (LIDB) 684 and transmit the call source information to the OSA/Parlay gateway 690 via a session initiation protocol (SIP) signal.

As indicated in FIG. 6, the acquisition tier 606 includes an acquisition tier (AQT) switch 652 that communicates with the private network 610. The AQT switch 652 can also communicate with the operations and management tier 608 via the public network 612. In a particular embodiment, the AQT switch 652 can be coupled to a live acquisition server 654 that receives or acquires television or movie content, for example, from a broadcast service 656. In a particular embodiment, the live acquisition server 654 can transmit the television or movie content to the AQT switch 652, and the AQT switch 652 can transmit the television or movie content to the CFT switch 630 via the private network 610.

In an illustrative embodiment, the television or movie content can be transmitted to the D-servers 632, where it can be encoded, formatted, stored, replicated, or otherwise manipulated and prepared for communication to the set-top box devices 616, 624. The CFT switch 630 can receive the television or movie content from the D-servers 632 and communicate the content to the CPE 614, 622 via the access network 666. The set-top box devices 616, 624 can receive the television or movie content via the CPE 614, 622, and can transmit the television or movie content to the television monitors 618, 626. In an illustrative embodiment, video or audio portions of the television or movie content can be streamed to the set-top box devices 616, 624.

Further, the AQT switch can be coupled to a video-on-demand importer server 658 that stores television or movie content received at the acquisition tier 606 and communicates the stored content to the VOD server 636 at the client-facing tier 602 via the private network 610. Additionally, at the acquisition tier 606, the video-on-demand (VOD) importer server 658 can receive content from one or more VOD sources outside the IPTV system 600, such as movie studios and programmers of non-live content. The VOD importer server 658 can transmit the VOD content to the AQT switch 652, and the AQT switch 652, in turn, can communicate the material to the CFT switch 630 via the private network 610. The VOD content can be stored at one or more servers, such as the VOD server 636.

When users issue requests for VOD content via the set-top box devices 616, 624, the requests can be transmitted over the access network 666 to the VOD server 636, via the CFT switch 630. Upon receiving such requests, the VOD server 636 can retrieve the requested VOD content and transmit the content to the set-top box devices 616,124 across the access network 666, via the CFT switch 630. The set-top box devices 616, 624 can transmit the VOD content to the television monitors 618, 626. In an illustrative embodiment, video or audio portions of VOD content can be streamed to the set-top box devices 616, 624.

FIG. 6 further illustrates that the operations and management tier 608 can include an operations and management tier (OMT) switch 660 that conducts communication between the operations and management tier 608 and the public network 612. In the embodiment illustrated by FIG. 6, the OMT switch 660 is coupled to a TV2 server 662. Additionally, the OMT switch 660 can be coupled to an OSS/BSS server 664 and to a simple network management protocol (SNMP) monitor 699 that monitors network devices within or coupled to the IPTV system 600. In a particular embodiment, the OMT switch 660 can communicate with the AQT switch 652 via the public network 612.

In an illustrative embodiment, the live acquisition server 654 can transmit the television or movie content to the AQT switch 652, and the AQT switch 652, in turn, can transmit the television or movie content to the OMT switch 660 via the public network 612. In this embodiment, the OMT switch 660 can transmit the television or movie content to the TV2 server 662 for display to users accessing the user interface at the TV2 server 662. For example, a user can access the TV2 server 662 using a personal computer (PC) coupled to the public network 612.

In a particular embodiment, a PSTN call from the caller POTS phone 698 can be received at the class 5 switch 676. The SCP 680 can detect that a connection is to be made between the source device and an IPTV user phone 695, for example, by detecting a termination attempt trigger (TAT) via an Advanced Intelligence Network (AIN) architecture. In an illustrative embodiment, the SCP 680 issues a query, such as a transaction capabilities application part (TCAP) query, to the LIDB 684 requesting caller ID information or other call source information related to the POTS phone 698, caller, or any combination thereof.

The SCP 680 transmits a session initiation protocol (SIP) signal that includes the call source information to the OSA/Parlay gateway 690. The OSA/Parlay gateway 690 sends the call source information to the application server 642, for example, via an application programming interface (API). Upon receiving call source information from the OSA/Parlay gateway 690, the application server 642 can query the LDAP database 646 to obtain IPTV user account information related to a destination telephone number of the call, such as a telephone number of the user phone 695. The application server 642 sends the call source information and IPTV user account information to the IPTV notification server(s) 686, for example, via an API.

In a particular embodiment, the IPTV notification server(s) 686 can obtain identifications of the set-top box device, such as the first representative set-top box 616 associated with the IPTV user account, such as alphanumeric identifiers, IP addresses, identifications of twisted pairs coupled to the set-top box, or any combination thereof. The IPTV notification server(s) 686 transmits the call source information to the identified set-top box device 616, and the set-top box 616 transmits the call source information to the television monitor 618. In an illustrative embodiment, the IPTV notification server(s) 686 can transmit data related to a graphical user interface (GUI) to the set-top box device 616 via an API, and the set-top box device 616 can draw or display the GUI at the television monitor 618. In another embodiment, the set-top box device 616 can generate the GUI from data related to the call source information.

In another particular embodiment, a wireless call from a caller cellular phone 682 can be received at the GSM switch 678. The SCP 680 can detect that a connection is to be made between the caller cellular phone 682 and a user GSM phone 697, for example, by detecting a customized applications for mobile enhanced logic (CAMEL) trigger via a CAMEL network architecture. In an illustrative embodiment, the service control point 680 issues a query, such as a transaction capabilities application part (TCAP) query, to the LIDB 684 requesting caller ID information or other call source information related to the caller cellular phone 682.

The SCP 680 transmits a session initiation protocol (SIP) signal that includes the call source information to the OSA/Parlay gateway 690. The OSA/Parlay gateway 690 sends the call source information to the application server 642, for example, via an application programming interface (API). Upon receiving call source information from the OSA/Parlay gateway 690, the application server 642 can query the LDAP database 646 to obtain IPTV user account information related to a destination telephone number of the call, such as a telephone number of the GSM phone 697. The application server 642 sends the call source information and IPTV user account information to the IPTV notification server(s) 686, for example, via an API.

In a particular embodiment, the IPTV notification server(s) 686 can obtain identifications of a set-top box device, such as the second representative set-top box 624 associated with the IPTV user account, such as alphanumeric identifiers, IP addresses, identifications of twisted pairs coupled to the set-top box, or any combination thereof. The IPTV notification server(s) 686 transmits the call source information to the identified set-top box device 624, and the set-top box 624 transmits the call source information to the television monitor 618. In an illustrative embodiment, the IPTV notification server(s) 686 can transmit data related to a graphical user interface (GUI) to the set-top box device 624 via an API, and the set-top box device 624 can draw or display the GUI at the television monitor 618. In another embodiment, the set-top box device 624 can generate the GUI from data related to the call source information.

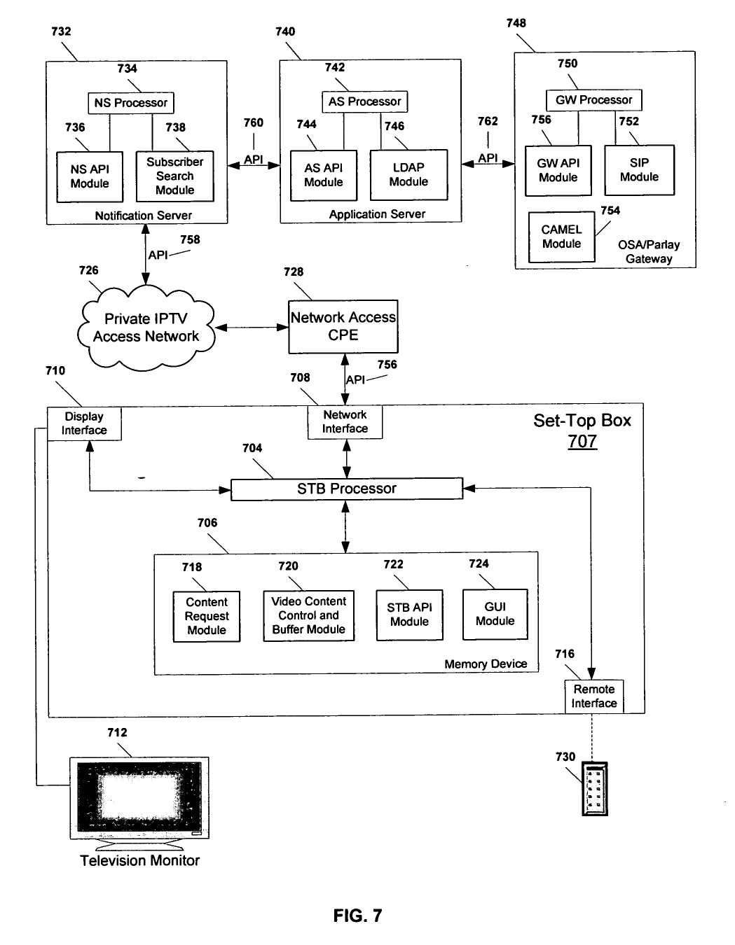

Referring to FIG. 7, an embodiment of a system to provide call source information is illustrated and designated generally at 700. The system includes a set-top box 702 that contains a STB processor 704 and a memory device 706 that is accessible to the STB processor 704. The STB processor 704 communicates with a network interface 708. Further, the STB processor 704 communicates with a display interface 710, such as a television interface, through which the set-top box device 702 can communicate video content, prompts, graphical user interfaces, or other content to an external display device, such as a television monitor 712. In addition, the STB processor 704 can communicate with a remote control device 732, via a remote control interface 716.

In an illustrative, non-limiting embodiment, the STB processor 704 can communicate with an external access network, such as an Internet Protocol Television (IPTV) access network 726, via the network interface 708. In a particular embodiment, network access customer premises equipment (CPE) 728 can facilitate communication between the network interface 708 and the IPTV access network 726. The network access CPE 728 can include a router, a local area network device, a modem, such as a digital subscriber line (DSL) modem, any other suitable device for facilitating communication between the network interface 708 of the set-top box device 702 and the IPTV access network 726, or any combination thereof.

In a particular embodiment, the memory device 706 can include a content request module 718 that is executable by the STB processor 704 to receive a request for video content from a user via the remote control device 732. For example, the request can be a channel change request or a video-on-demand request. The content request module 718 can be executable by the STB processor 704 to request and receive the video content from a server of an IPTV system via the IPTV access network 726. The memory device 706 can also include a video content control and buffer module 720 that is executable by the STB processor 704 to receive video content requested by a user and to buffer the video content before transmitting it to the display interface 710, in order to prevent underflow.

Further, the memory device 706 can include a STB application programming interface (API) module 722 that is executable by the STB processor 704 to communicate with the remote control device 732, for example, to receive a first API 758 from a notification server 732 via the private IPTV access network 726. The first API 758 can include call source information related to a source of a PSTN, wireless, or VoIP call that is to be connected with an IPTV user phone. In a particular embodiment, the first API 758 can also include data related to a graphical user interface (GUI) to display the call source information at the television monitor 712. In another embodiment, the STB API module 722 can be executable by the STB processor 704 to instruct a GUI module 724 to generate a GUI that includes the call source information received with the first API 758 and to transmit the GUI to the television monitor 712 via the display interface 710.

In a particular embodiment, the notification server 732 can include a NS processor 734. The notification server 732 can include a NS API module 736 that is executable by the NS processor 734 to receive a second API 760 from an application server 740, such as a caller ID application server or other mediation messaging server of an IPTV system. The second API 760 can include the call source information and information related to an IPTV user account associated with a destination telephone number of the call. In an illustrative embodiment, the notification server 732 can include a subscriber search module 736 that is executable by the NS processor 734 to search a subscriber information store of the IPTV system, such as the subscriber/system store 648 illustrated in FIG. 6, to determine one or more set-top boxes to which the call source information should be sent based on the IPTV user account information. The NS API module 736 can be executable by the NS processor 734 to send the first API 758 to the set-top box device 702 via the IPTV access network 726.

In another particular embodiment, the application server 740 can include an AS processor 742. The application server 740 can include an AS API module 744 that is executable by the AS processor 742 to receive a third API 762 from an open service access (OSA)/Parlay gateway 748 of the IPTV system. The third API 762 can include call source information related to the call. In an illustrative embodiment, the application server 740 can include a LDAP module 746 that is executable by the AS processor 742 to query a LDAP database of the IPTV system to request IPTV user account information associated with a destination telephone number of the call. The AS API module 744 is executable by the AS processor 742 to send the second API 760 to the notification server 732.

In another particular embodiment, the OSA/Parlay gateway 748 can include a GW processor 750. In an illustrative embodiment, the OSA/Parlay gateway 748 can include a session initiation protocol (SIP) module 752 that is executable by the GW processor 750 to receive a SIP signal that contains call source information from a SIP-enhanced service control point of a signaling system 7 (SS7) network or from a GR 303-based gateway. In another illustrative embodiment, the OSA/Parlay gateway 748 can include a customized applications for mobile enhanced logic (CAMEL) module 754 that is executable by the GW processor 750 to receive a CAMEL signal that contains call source information from a CAMEL-enhanced service control point of a signaling system 7 (SS7) network or from a global system for mobile communication (GSM) switch. Further, the OSA/Parlay gateway 748 can include a GW API module 756 that is executable by the GW processor 750 to transmit the third API 762 to the application server 740.

The numbering of APIs 758-762 as first, second or third is to promote ease of description and does not refer to any sequence in which the signals are sent.

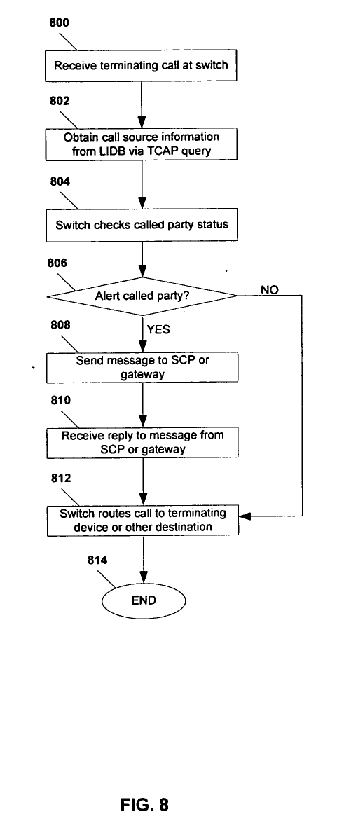

Referring to FIG. 8, a particular embodiment of a method of providing call source information is illustrated. At block 800, a terminating call is received at a switch. In a particular embodiment, the call can be a plain old telephone service (POTS) call received at a class 5 switch of a public switched telephone network (PSTN). In another embodiment, the call can be a wireless call received at a global system for mobile communication (GSM) switch. Moving to block 802, in a particular embodiment, the switch can obtain call source information, such as caller identification information, from a line information database (LIDB). In an illustrative embodiment, the switch can issue a transaction capabilities application part (TCAP) query to the LIDB.

Continuing to block 804, in an illustrative embodiment, the switch can check a status of the called party, such as whether the terminating device is in use, whether the called party has forwarded calls, or other status information related to the called party. Proceeding to decision step 806, the switch determines whether to alert the called party of the terminating call, for example, based on the status information. If the switch determines that the called party is not to be alerted of the terminating call, the method advances to block 812, and the switch routes the terminating call to a terminating user device, such as a user phone, a voice mail system, or a phone to which the user has forwarded calls. On the other hand, if the switch determines that the called party is not to be alerted, the method continues to block 808.

At block 808, the switch sends a message to a service control point (SCP) of a signaling system 7 (SS7) network or to an open service access/Parlay (OSA/Parlay) gateway. The message can include an indication that a call is to be made between a source device and the terminating device. Further, the message can include call source information obtained by the switch from the LIDB. In a particular embodiment, a class 5 switch can send an Advanced Intelligence Network (AIN) message to a service control point (SCP), which can forward the information via a session initiation protocol (SIP) signal to a gateway server of an Internet Protocol Television (IPTV) system, such as an open service access/Parlay (OSA/Parlay) gateway server. In another particular embodiment, the switch can send the AIN message to the OSA/Parlay gateway. In another particular embodiment, a GSM switch can send a customized applications for mobile enhanced logic (CAMEL) message to the SCP or to the OSA/Parlay gateway.

Continuing to block 810, the switch receives a reply to the AIN message from the SCP or gateway server. In one embodiment, the reply can include instructions to route the call to the terminating device or other system or device designated by the called party. At block 812, the switch routes the call to the terminating device or other destination. The method terminates at 814.

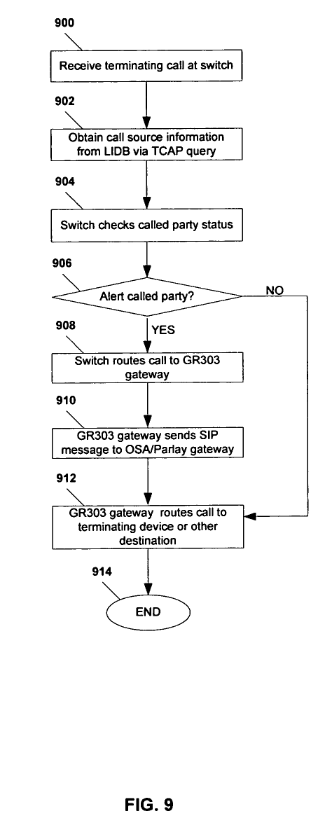

Referring to FIG. 9, an illustrative, non-limiting embodiment of a method of providing call source information is illustrated. At block 900, a terminating call is received at a class 5 switch of a public switched telephone network (PSTN). Moving to block 902, in a particular embodiment, the switch can obtain call source information, such as caller identification information, from a line information database (LIDB). In an illustrative embodiment, the switch can issue a transaction capabilities application part (TCAP) query to the LIDB. Continuing to block 904, in an illustrative embodiment, the switch can check a status of the called party, such as whether the terminating device is in use, whether the called party has forwarded calls, or other status information related to the called party.

Proceeding to decision step 906, the switch determines whether to alert the called party of the terminating call, for example, based on the status information. If the switch determines that the called party is not to be alerted of the terminating call, the method advances to block 912, and the switch routes the terminating call to a terminating user device, such as a user phone, a voice mail system, or a phone to which the user has forwarded calls. On the other hand, if the switch determines that the called party is not to be alerted, the method continues to block 908.

At block 908, the switch routes the call to a GR303-based gateway. Continuing to block 910, the GR303-based gateway can send a message to a gateway server of an Internet Protocol Television (IPTV) system, such as an open service access/Parlay (OSA/Parlay) gateway server. In an illustrative embodiment, the message can be sent via a session initiation protocol (SIP) signal and can include an indication that a call is to be made between a source device and the terminating device. Further, the message can include call source information obtained by the switch from the LIDB. At block 912, the GR303-based gateway routes the call to the terminating device or other destination. The method terminates at 914.

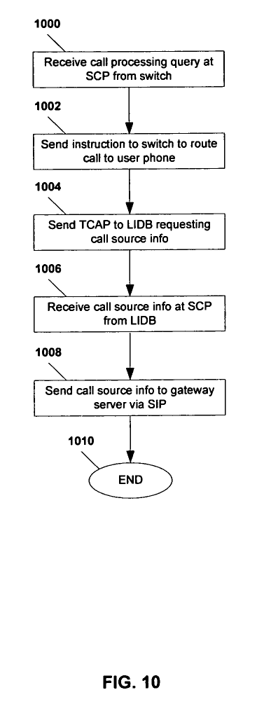

Referring to FIG. 10, a third particular embodiment of a method of providing call source information is illustrated. At block 1000, a service control point (SCP) of a signaling system 7 (SS7) network receives a call message. In one embodiment, the message can be an Advance Intelligence Protocol (AIN) message received from a class 5 switch of a Public Switched Telephone Network (PSTN). In another embodiment, the message can be a customized applications for mobile enhanced logic (CAMEL) message received from a global system for mobile communication (GSM) switch. The message can include an indication that a call is to be connected from a source device to a terminating device of a user. In an illustrative, non-limiting embodiment, the method proceeds to block 1002, and the SCP sends a reply to the message to the switch. The reply can include a command or instructions to route the call to a user phone, such as a Voice-over Internet Protocol (VOIP) phone, wireless phone, plain old telephone service (POTS) phone, or other user phone, or to route the call to another destination, such as a voice mail system or forwarding destination.

Moving to block 1004, in a particular embodiment, the SCP issues a transaction capabilities application part (TCAP) query to a line information database (LIDB) requesting call source information related to a caller phone, caller, or any combination thereof. Proceeding to block 1006, the SCP receives the call source information from the LIDB. Continuing to block 1008, the SCP transmits a session initiation protocol (SIP) signal that includes the call source information to a gateway server of an Internet Protocol Television (IPTV) system, such as an open service access (OSA)/Parlay gateway server. The SIP signal can include an INVITE message, an INFO message, a NOTIFY message, or any combination thereof. In an illustrative embodiment, the gateway server can send the call source information to a set-top box device associated with the user via a notification server of the IPTV system. The method terminates at 1010.

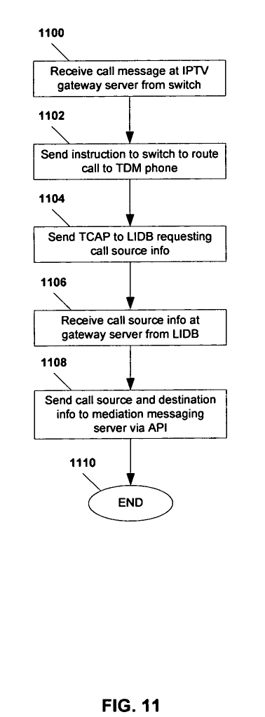

Referring to FIG. 11, a fourth particular embodiment of a method of providing call source information is illustrated. At block 1100, a gateway server of an Internet Protocol Television (IPTV) system receives a call message. In an illustrative embodiment, the gateway server can be an open service access (OSA)/Parlay gateway server. The message can be an Advance Intelligence Protocol (AIN) message received from a class 5 switch of a Public Switched Telephone Network (PSTN). In another embodiment, the message can be a customized applications for mobile enhanced logic (CAMEL) message received from a global system for mobile communication (GSM) switch. The message can include an indication that a call is to be connected from a source device to a terminating device of a user. Moving to block 1102, the gateway server sends a command or instructions to the switch to route the call to a user phone, such as a Voice-over Internet Protocol (VoIP) phone, wireless phone, plain old telephone service (POTS) phone, or other user phone.

Proceeding to block 1104, in a particular embodiment, the gateway server can issue a transaction capabilities application part (TCAP) query to a line information database (LIDB) requesting call source information related to a caller phone, caller, or any combination thereof. Proceeding to block 1106, the gateway server receives the call source information from the LIDB. Continuing to block 1108, the gateway server transmits an application programming interface (API) signal that includes the call source information and call destination information to a mediation messaging server of the IPTV system, such as a caller identification (caller ID) application server. In an illustrative embodiment, the API signal can be a Parlay API signal running on Common Object Request Broker Architecture (CORBA) middleware. In a particular embodiment, the mediation messaging server can determine an IPTV user account associated with the call destination information and can send the call source information and user account information to a notification server of the IPTV system. The notification server can send the call source information to a set-top box device associated with the IPTV user account. The method terminates at 1110.

Referring to FIG. 12, a fifth particular embodiment of a method of providing call source information is illustrated. At block 1200, a mediation messaging server of an Internet Protocol Television (IPTV) system, such as a caller identification (caller ID) application server, receives source and destination information related to a call from a gateway server of the IPTV system, such as an Open Service Access/Parlay (OSA/Parlay) gateway. In a particular embodiment, the source and destination information can be received via an application programming interface (API) signal issued by the gateway server.

Moving to block 1202, in an illustrative embodiment, the mediation messaging server can request IPTV user account information associated with a destination telephone number of the call to a mediation database. In an illustrative embodiment, the mediation messaging server can issue a lightweight directory access protocol (LDAP) query to a LDAP directory or database. In an illustrative embodiment, the destination telephone number can be associated with a Voice-over Internet Protocol (VOIP) phone, a wireless phone, such as a mobile or cellular phone, or a plain old telephone service (POTS) phone. Continuing to block 1204, the application server receives the IPTV user account information associated with the destination telephone number.

Proceeding to block 1206, the mediation messaging server sends a notification request to a notification server of the IPTV system. The request can include the call source information and IPTV user account information. In an illustrative embodiment, the notification server can identify one or more set-top box devices communicating with the IPTV system based on the IPTV user account information and can transmit the call source information to the set-top box device(s). The method terminates at 1208.

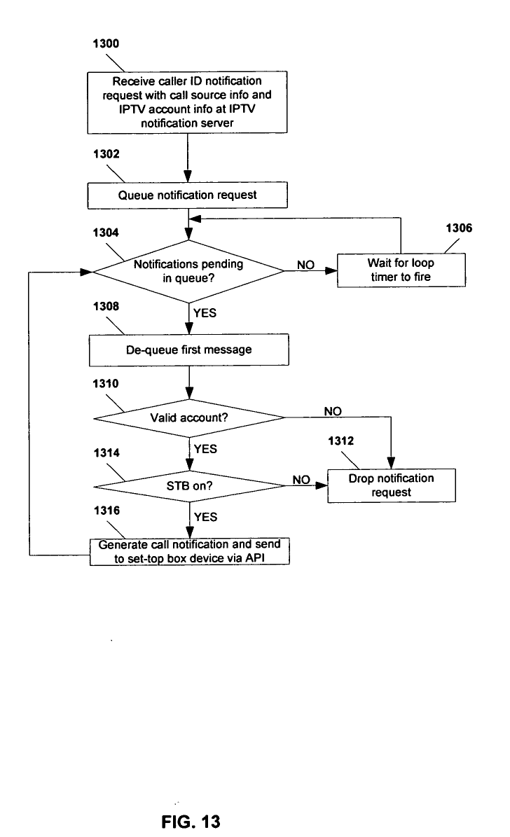

Referring to FIG. 13, a third particular embodiment of a method of providing call source information is illustrated. At block 1300, a notification server of an Internet Protocol Television (IPTV) system, receives a call notification request from a mediation messaging server of the IPTV system, such as a caller identification (caller ID) application server. The notification server can receive call source information and IPTV user account information associated with a destination telephone number of the call with the notification request. In a particular embodiment, the call source and user account information can be received via an application programming interface (API) signal issued by the mediation messaging server.

Moving to block 1302, in a particular embodiment, the notification server can place the notification request issue into a queue. Continuing to decision step 1304, the notification server can determine whether any notifications are pending in the queue. If no notifications are pending in the queue, the method proceeds to block 1306. At block 1306, in an illustrative embodiment, the notification server waits for a loop timer to fire before determining again whether any notifications are pending in the queue.

Returning to decision step 1304, if one or more notification requests are pending in the queue, the method advances to block 1308, and the notification server can remove a first notification request from the queue, such as a message at a highest-priority or first-received queue position. Moving to decision step 1310, in a particular embodiment, the notification server can determine whether the notification request is associated with a valid account. If the notification request is not associated with a valid account, the method proceeds to block 1312, and the notification request is dropped. Conversely, if the notification is associated with a valid account, the method moves to decision step 1314, and the notification server can determine whether a set-top box device associated with the received IPTV user account information is activated. In one embodiment, the notification server can issue a query to a subscriber information store of the IPTV system requesting identifications of one or more set-top box devices associated with IPTV user account information received from the mediation messaging server. In an illustrative embodiment, the set-top box identifiers can include alphanumeric identifiers, IP addresses, identifications of twisted pairs coupled to the set-top box, or any combination thereof.

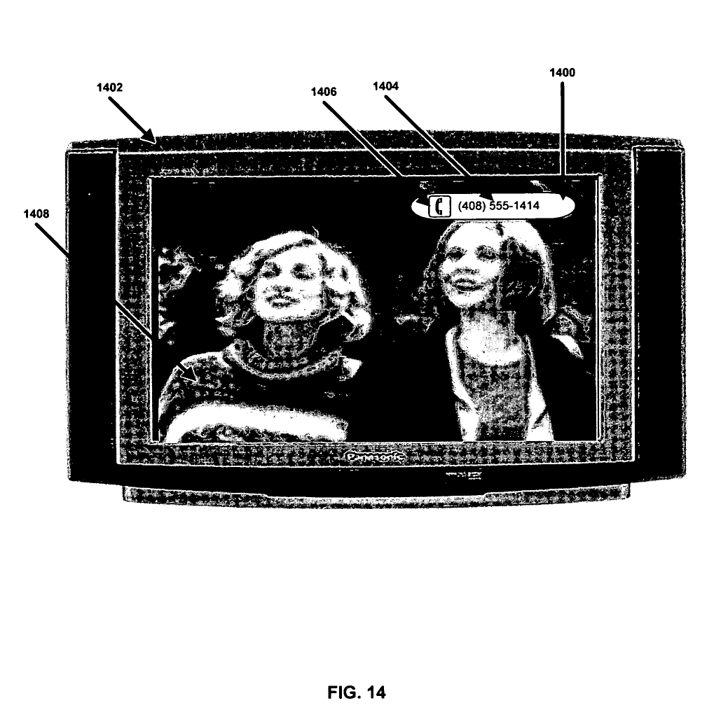

If the set-top box device is not activated, the method returns to block 1312, and the notification request is dropped. On the other hand, if the set-top box is activated, the method advances to block 1316, and the notification server sends a call notification to the set-top box device. In an illustrative embodiment, the notification server can generate a call notification based on the call source information. In an illustrative embodiment, the notification can include a graphical user interface (GUI) that overlays video content displayed on a display device coupled to the set-top box device(s), such as the call notification illustrated in FIG. 14. The method then returns to decisions step 1304 and continues.

In a particular embodiment, the steps of the methods described herein are executed in the order shown by the figures. In alternative embodiments, the steps may be executed in alternative sequences.

Referring to FIG. 14, a diagram of an embodiment of a user interface to receive calls is shown at 1400. The user interface 1400 can be displayed at a display device, such as a television monitor 1402. In the embodiment shown in FIG. 14, the user interface 1400 includes a telephone call notification. The user interface 1400 can overlay television content 1408 and can contain multiple types of information. For example, the user interface 1400 for the telephone call notification can include a caller or destination telephone number 1404 and a telephone call symbol 1406.

In conjunction with the configuration of structure described herein, the system and method disclosed provide source information related to a call at a display device coupled to a set-top box device associated with a customer, subscriber, or other user of an Internet Protocol Television (IPTV) system. In a particular embodiment, a call is received at a switch if a telephone network, such as a Public Switched Telephone Network (PSTN) or wireless network. Call source and destination information is received at a gateway server of the IPTV system, such as an Open Service Access (OSA)/Parlay gateway. In one embodiment, the call source information can be received from the switch or from a service control point of a signaling system 7 (SS7) network. In another embodiment, the gateway server can retrieve the call source information from a line information database.

In an illustrative embodiment, the gateway server sends the call source and destination information to an application server of the IPTV system, for example, via an API. The application server can determine IPTV user account information associated with the destination telephone number, for example, by querying a Lightweight Directory Access Protocol (LDAP) directory or database. The application server can send the call source information and IPTV user account information to a notification server that determines one or more set-top boxes associated with the IPTV user account information and sends the call source information to the set-top box device(s). In one embodiment, the notification server can generate a graphical user interface (GUI) or other call notification containing the call source information. In another embodiment, the notification server can send the call source information to the set-top box device(s), and the set-top box device(s) can generate a graphical user interface (GUI) or other call notification containing the call source information.

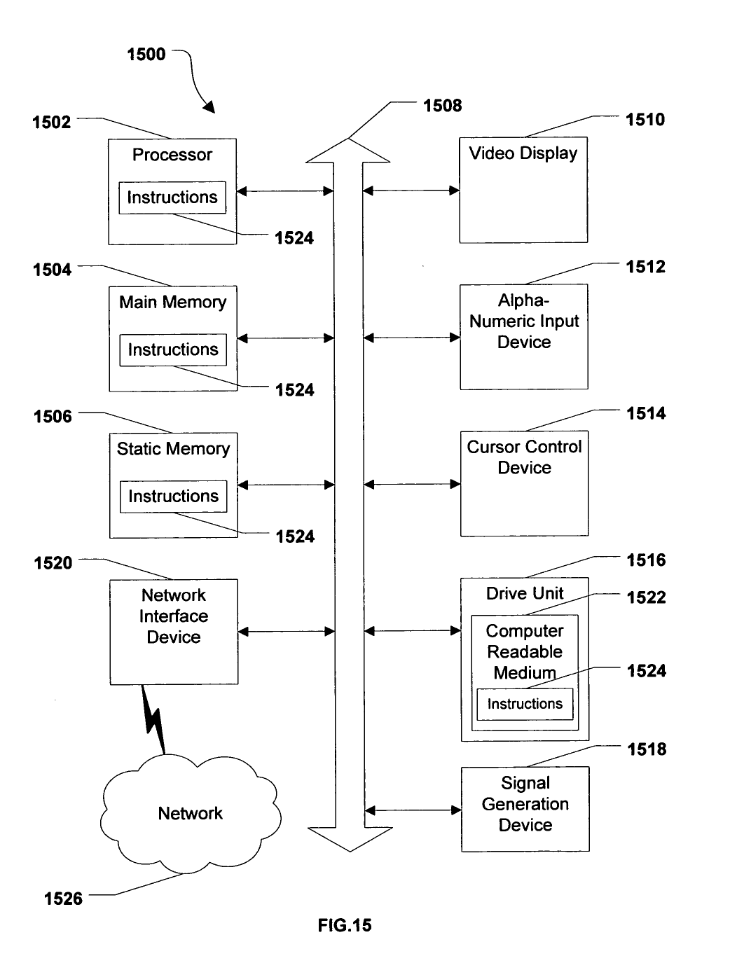

Referring to FIG. 15, an illustrative embodiment of a general computer system is shown and is designated 1500. The computer system 1500 can include a set of instructions that can be executed to cause the computer system 1500 to perform any one or more of the methods or computer based functions disclosed herein. The computer system 1500, or any portion thereof, may operate as a standalone device or may be connected, e.g., using a network, to other computer systems or peripheral devices, including a server or set-top box device, as shown in FIGS. 1-7.

In a networked deployment, the computer system may operate in the capacity of an IPTV server or set-top box device. The computer system 1500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1500 can be implemented using electronic devices that provide voice, video or data communication. Further, while a single computer system 1500 is illustrated, the term “system” shall also be taken to include any collection of systems or sub-systems that individually orjointly execute a set, or multiple sets, of instructions to perform one or more computer functions.

As illustrated in FIG. 15, the computer system 1500 may include a processor 1502, e.g., a central processing unit (CPU), a graphics-processing unit (GPU), or both. Moreover, the computer system 1500 can include a main memory 1504 and a static memory 1506 that can communicate with each other via a bus 1508. As shown, the computer system 1500 may further include a video display unit 1510, such as a liquid crystal display (LCD), an organic light emitting diode (OLED), a flat panel display, a solid state display, or a cathode ray tube (CRT). Additionally, the computer system 1500 may include an input device 1512, such as a keyboard, and a cursor control device 1514, such as a mouse. Further, the computer system 1500 can include a wireless input device 1515, e.g., a remote control device. The computer system 1500 can also include a disk drive unit 1516, a signal generation device 1518, such as a speaker or remote control, and a network interface device 1520.

In a particular embodiment, as depicted in FIG. 15, the disk drive unit 1516 may include a computer-readable medium 1522 in which one or more sets of instructions 1524, e.g. software, can be embedded. Further, the instructions 1524 may embody one or more of the methods or logic as described herein. In a particular embodiment, the instructions 1524 may reside completely, or at least partially, within the main memory 1504, the static memory 1506, and/or within the processor 1502 during execution by the computer system 1500. The main memory 1504 and the processor 1502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1524 or receives and executes instructions 1524 responsive to a propagated signal, so that a device connected to a network 1526 can communicate voice, video or data over the network 1526. Further, the instructions 1524 may be transmitted or received over the network 1526 via the network interface device 1520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing call source information, the method comprising:
receiving call source information and call destination information at a mediation messaging server of an Internet Protocol Television (IPTV) system, wherein the call source information and the call destination information are related to a call received via at least one of a switch of a Public Switched Telephone Network (PSTN) and a wireless telephone network;
determining account information based on the call destination information; and
sending the account information and the call source information to a notification server of the IPTV system, wherein the notification server sends the call source information to a set-top box device of an IPTV user via an access network of the IPTV system.

2. The method of claim 1, further comprising querying a mediation database of the IPTV system to retrieve the account information.

3. The method of claim 2, wherein the mediation database is a Lightweight Directory Access Protocol (LDAP) database.

4. The method of claim 1, wherein the mediation messaging server receives the call source information and the call destination information from the switch via a gateway server of the IPTV system.

5. The method of claim 4, wherein the gateway server is an Open Service Access/Parlay gateway.

6. The method of claim 4, wherein the mediation messaging server receives the call source information and the call destination information from the gateway server via an Application Programming Interface (API).

7. The method of claim 6, wherein the gateway server retrieves the call source information from a line information database via a transaction capabilities application part (TCAP) query.

8. The method of claim 1, wherein the account information and the call source information is sent to the notification server via an Application Programming Interface (API).

9. A method of providing call source information, the method comprising:
receiving call source information and account information at a notification server of an Internet Protocol Television (IPTV) system, wherein the call source information is related to a call received via at least one of a Public Switched Telephone Network (PSTN) or a wireless telephone network;
determining a set-top box device associated with the account information; and
sending the call source information to the set-top box device via an access network of the IPTV system.

10. The method of claim 9, wherein the call source information and the account information is received from a mediation messaging server of the IPTV system.

11. The method of claim 9, further comprising issuing a query to a subscriber information store of the IPTV system requesting at least one identification of the set-top box device.

12. The method of claim 11, wherein the at least one identification includes an alphanumeric identifier, an Internet Protocol address, an identification of a twisted pair, an identification of a fiber loop, or any combination thereof.

13. The method of claim 9, further comprising generating a graphical user interface (GUI) that includes the call source information.

14. The method of claim 9, wherein the call source information is sent to the set-top box device via an application programming interface (API).

15. A method of receiving call source information, the method comprising:
receiving call source information at a set-top box device from a notification server via an access network of an Internet Protocol Television (IPTV) system, wherein the call source information is related to a call routed via at least one of a Public Switched Telephone Network (PSTN) and a wireless telephone network; and
sending a graphical user interface (GUI) containing the call source information to a display device coupled to the set-top box device.

16. The method of claim 15, further comprising generating the GUI at the set-top box device.

17. The method of claim 15, wherein the call source information includes caller identification (caller ID) information corresponding to a source of the call.

18. A system to provide call source information, the system comprising:
a mediation messaging server of an Internet Protocol Television (IPTV) system, the mediation messaging server including a processor and a memory device accessible to the processor;
wherein the memory device includes an Application Programming Interface (API) module executable by the processor to receive call source information and call destination information related to a call received at a switch of a communications network;
wherein the memory device includes a Lightweight Directory Access Protocol (LDAP) module executable by the processor to query a LDAP database of the IPTV system to determine account information of an IPTV user based on the call destination information; and
wherein the API module is executable by the processor to send the account information and the call source information to a notification server of the IPTV system and the notification server sends the call source information to a set-top box device of the IPTV user via an access network of the IPTV system.

19. The system of claim 18, wherein the switch is a class 5 switch of the PSTN.

20. The system of claim 19, wherein the class 5 switch obtains the call source information from a line information database via a transaction capabilities application part (TCAP) query.

21. The system of claim 19, wherein the class 5 switch is coupled to a service control point (SCP) of a signaling system 7 (SS7) network and the SCP retrieves the call source information from a line information database via a transaction capabilities application part (TCAP) query.

22. The system of claim 18, wherein the switch is a global system for mobile communication (GSM) switch.

23. The system of claim 22, wherein the GSM switch is coupled to a service control point (SCP) of a signaling system 7 (SS7) network and the SCP retrieves the call source information from a line information database via a transaction capabilities application part query.

24. The system of claim 18, wherein the mediation messaging server is a caller identification (caller ID) application server.

25. A set-top box device, comprising:
a processor and a memory device accessible to the processor;
wherein the memory device includes an Application Programming Interface (API) module executable by the processor to receive call source information from a notification server via an access network of an Internet Protocol Television (IPTV) system, wherein the call source information is related to a call received at a switch of a communications network; and
wherein the memory device includes a graphical user interface (GUI) module executable by the processor to send a graphical user interface (GUI) containing the call source information to a display device coupled to the set-top box device.

26. The set-top box device of claim 25, wherein the GUI module is executable by the processor to generate the GUI.

27. A computer program embedded in a computer-readable medium, the computer program comprising:
instructions to receive call source information and call destination information related to a call received at a telephony switch;
instructions to query a LDAP database of an Internet Protocol Television (IPTV) system to determine account information of an IPTV user based on the call destination information; and
instructions to send the account information and the call source information to a notification server of the IPTV system, wherein the notification server sends the call source information to a set-top box device of the IPTV user via an access network of the IPTV system.

28. The computer program of claim 27, wherein the call source information is received from an open service access (OSA)/Parlay gateway server of the IPTV system.

29. The computer program of claim 28, wherein the (OSA)/Parlay gateway server detects the call at the switch via a customized applications for mobile enhanced logic (CAMEL) trigger.

30. The computer program of claim 27, wherein the (OSA)/Parlay gateway server detects the call at the switch via a termination attempt trigger (TAT).

31. A computer program embedded in a computer-readable medium, the computer program comprising:
instructions to receive call source information from a notification server via an access network of an Internet Protocol Television (IPTV) system, wherein the call source information is related to a call received at a switch of a public telephone network; and
instructions to send a graphical user interface (GUI) containing the call source information to a display device coupled to the set-top box device.

32. The computer program of claim 31, further comprising instructions to generate the GUI.
